(19) United States
(12) Patent Application Publication
(10) Pub. No.: US 2020/0386274 A1
(43) Pub. Date: Dec. 10, 2020

(54) TORQUE DAMPER APPARATUS

(71) Applicants: Honda Motor Co., Ltd., Tokyo (JP); c/o Kabushiki Kaisha F.C.C., Hamamatsu-shi (JP)

(72) Inventors: Tomohiko Usui, Wako-shi (JP); Yasuhiro Morimoto, Wako-shi (JP); Tetsuya Naito, Hamamatsu-shi (JP)

(21) Appl. No.: 16/885,473

(22) Filed: May 28, 2020

(30) Foreign Application Priority Data
Jun. 7, 2019 (JP) 2019-106663

(51) Int. Cl. F16D 3/12; F16F 15/123

(52) U.S. Cl. CPC F16D 3/12; F16H 2045/0221; F16F 15/123

(57) ABSTRACT

A torque damper apparatus including an input plate, an intermediate plate, an output plate, and a spring member interposed between the intermediate plate and the output plate so that the torque transmitted from the intermediate plate to the output plate is reduced. The output plate includes a pair of plates arranged so as to separate from each other in an axial direction and a fastening part fastening the pair of plates. The spring member is a coiled spring arranged along a circumferential direction about the axial line, and the intermediate plate includes a holding portion holding an inner end of the spring member in a radial direction about the axial line, and a plate portion extended from the holding portion toward an inside in the radial direction between the pair of plates and supported rotatably relative to the fastening part.

### CROSS-REFERENCE TO RELATED APPLICATION

This application is based upon and claims the benefit of priority from Japanese Patent Application No. 2019-106663 filed on Jun. 7, 2019, the content of which is incorporated herein by reference.

### BACKGROUND OF THE INVENTION

### Field of the Invention

This invention relates to a torque damper apparatus reducing torque variation.

### Description of the Related Art

Conventionally, there is a known apparatus reducing torque variation, so as to prevent torque variation caused by variations in the rotation of an engine from being directly transmitted to a transmission during actuation of a lock-up mechanism provided in a torque converter. This apparatus is described in Japanese Unexamined Patent Publication No. 2014-202228 (JP2014-202228A), for example. The apparatus of JP2014-202228A includes a window portion provided at a torque transmission member configured to transmit an engine torque to a turbine runner through a damper spring, and a member for transmitting a torque output from a lock-up clutch to the damper spring through the window portion.

Although the apparatus of JP2014-202228A is configured to reduce a size of the apparatus in the axial direction, it increases number of components.

### SUMMARY OF THE INVENTION

An aspect of the present invention is a torque damper apparatus, disposed on a torque transmission path to an output shaft from a clutch device to which a torque output from an engine is input, so as to be rotatable about an axial line. The torque damper apparatus includes an input plate to which a torque is input from the clutch device; an intermediate plate fastened to the input plate; an output plate to which a torque is transmitted from the intermediate plate; and a spring member interposed between the intermediate plate and the output plate so that the torque transmitted from the intermediate plate to the output plate is reduced. The output plate includes a pair of plates arranged so as to separate from each other in an axial direction and a fastening part configured to fasten the pair of plates, the spring member is a coiled spring arranged in an expanded and contracted manner along a circumferential direction about the axial line, and the intermediate plate includes a holding portion configured to hold an inside end of the spring member in a radial direction about the axial line, and a plate portion extended from the holding portion toward an inside in the radial direction between the pair of plates and supported rotatably relative to the fastening part.

### BRIEF DESCRIPTION OF THE DRAWINGS

The objects, features, and advantages of the present invention will become clearer from the following description of embodiments in relation to the attached drawings, in which:

FIG. 1 is a cross sectional view of a torque converter to which a torque damper apparatus according to an embodiment of the present invention is applied;

FIG. 2 is an enlarged sectional view showing configurations of main components of the torque damper apparatus of FIG. 1;

FIG. 3 is a rear view of the torque damper apparatus of FIG. 2;

FIG. 4 is a view showing a state where a part of the torque damper apparatus is omitted from FIG. 3;

FIG. 5 is a front view of the torque damper apparatus of FIG. 2;

FIG. 6 is a view showing a state where a part of the torque damper apparatus is omitted from FIG. 5;

FIG. 7 is a perspective view of a portion B of FIG. 4 seen obliquely from rear side; and

FIG. 8 is a perspective view of main components of a drive plate of the torque damper apparatus of FIG. 2 seen obliquely from front side.

### DETAILED DESCRIPTION OF THE INVENTION

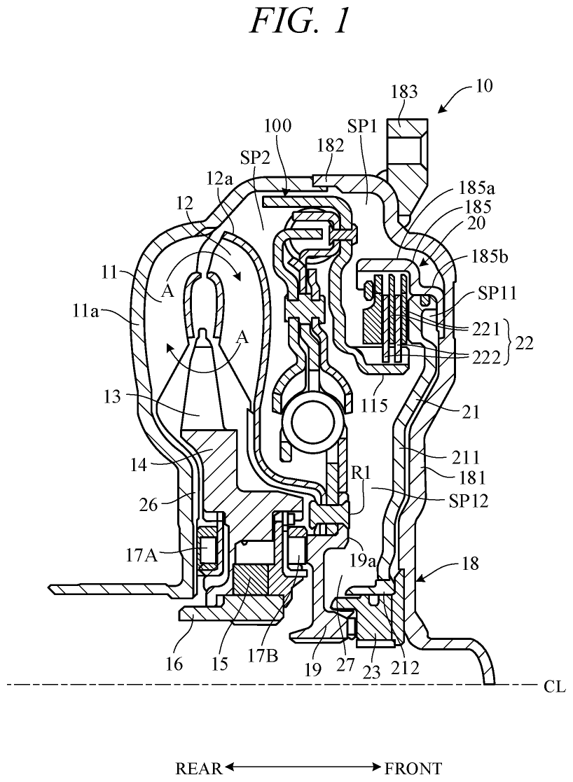

Hereinafter, an embodiment of the present invention is explained with reference to FIGS. 1 to 8. A torque damper apparatus according to an embodiment of the invention is applied to a torque converter with a lock-up mechanism of a vehicle, for example. FIG. 1 is a cross-sectional view of a torque converter 10 to which a torque damper apparatus 100 according to the embodiment of the invention is applied. For convenience, a direction along an axis (axial line) CL shown in FIG. 1 is defined as a front-rear direction, and the configuration of the components will be described in accordance with the definition.

As shown in FIG. 1, the torque converter 10 includes a pump impeller 11 connected to the output shaft (crankshaft) of an engine (not shown) disposed in front of the torque converter 10 and a turbine runner 12 connected to the input shaft of a transmission (not shown) disposed in the rear. The pump impeller 11 and turbine runner 12 are disposed so as to be rotatable about an axis CL. The turbine runner 12 is disposed in front of the pump impeller 11 so as to face the pump impeller 11, and a fluid (oil) circulation path shown by an arrow A is formed between the pump impeller 11 and turbine runner 12.

A stator 13 is disposed between the pump impeller 11 and turbine runner 12 and on the radial inside of the pump impeller 11 and turbine runner 12. The stator 13 is supported by a stator hub 14 disposed on the radial inside thereof, and the stator hub 14 is supported by an inner ring 16 through a one-way clutch 15. The inner ring 16 has an inner circumferential surface fitted to a stator shaft of the transmission (not shown) and is unrotatably fixed to a case. A thrust bearing 17A is disposed between the stator hub 14 and a shell 11a of the pump impeller 11.

A cover 18 is disposed in front of the turbine runner 12. The cover 18 includes a first plate 181 that extends approximately radially and a second plate 182 that extends so as to be bent rearward from the radially outer end of the first plate 181. The second plate 182 is approximately in the shape of a cylinder centered on the axis CL and has a rear end joined to the shell 11a of the pump impeller 11 by welding or the like. Thus, a space SP1 is formed between the cover 18 and turbine runner 12. A boss 183 is disposed on the outer circumferential surface of the second plate 182 so as to protrude radially outward. A torque outputted from the output shaft of the engine is inputted to the pump impeller 11 through the boss 183 and cover 18.

A turbine hub 19 is disposed between the stator hub 14 and the first plate 181 of the cover 18. The turbine hub 19 is disposed behind a piston support 23 disposed behind the cover 18. The central axis of the turbine hub 19 is consistent with the axis CL. The input shaft of the transmission (not shown) is disposed on the radial inside of the turbine hub 19. The turbine hub 19 is fixed to the input shaft of the transmission through splines formed on the inner circumferential surface thereof and rotates integrally with the input shaft. A thrust bearing 17B is disposed between the turbine hub 19 and stator hub 14.

A flange 19a is provided on the outer circumferential surface of the turbine hub 19 so as to protrude radially outward. The radially inner end of the shell 12a of the turbine runner 12 is fixed to the rear surface of the flange 19a by rivets R1. The shell 12a may be fixed to the flange 19a by welding. The radially outer end of the shell 12a is bent rearward. A surplus space SP2 connected to the space SP1 is formed on the radial outside of the shell 12a and on the radial inside of the shell 11a of the pump impeller 11.

When the pump impeller 11 is rotated by rotation of the output shaft of the engine in the torque converter 10 thus configured, oil flows from the pump impeller 11 to the turbine runner 12. The oil drives the turbine runner 12, then passes through the stator 13, and returns to the pump impeller 11. That is, the oil flows along the circulation path A in FIG. 1 between the pump impeller 11, turbine runner 12, and stator 13. This oil flow reduces the rotation of the output shaft of the engine and increases the torque, and the resulting rotation and torque are transmitted to the input shaft of the transmission.

The torque converter 10 includes a lock-up clutch 20 that mechanically couples the turbine hub 19 and cover 18. Since the lock-up clutch 20 couples the turbine hub 19 and cover 18 at a predetermined timing, the torque transmission loss can be reduced compared to that when transmitting the torque using liquid.

The lock-up clutch 20 includes a clutch piston 21 disposed behind the first plate 181 of the cover 18 so as to face the first plate 181 and multiple clutch plates 22 disposed behind the clutch piston 21 so as to face the radially outer end of the clutch piston 21. The clutch piston 21 includes a first plate 211 that extends approximately radially and a second plate 212 that extends rearward from the radially inner end of the first plate 211.

An approximately cylindrical tube plate 185 centered on the axis CL is disposed on the radial outside of the second plate 212. The tube plate 185 includes an approximately cylindrical large-diameter portion 185a and an approximately cylindrical small-diameter portion 185b disposed in front of the large-diameter portion 185a. The front end of the small-diameter portion 185b is fixed to the first plate 181 of the cover 18. The outer circumferential surface of the first plate 211 of the clutch piston 21 is fitted in the inner circumferential surface of the small-diameter portion 185b so as to be movable in the front-rear direction.

The second plate 212 is formed in an approximate cylindrical shape centered on the axis CL. The outer circumferential surface of the piston support 23 is fitted in the inner circumferential surface of the second plate 212 so as to be movable in the front-rear direction. The piston support 23 is formed integrally with the cover 18 by welding or the like.

The clutch plates 22 are disposed so as to face the rear surface of the radially outer end of the first plate 211. The clutch plates 22 includes driving clutch plates 221 and driven clutch plates 222 approximately in annular shapes in front view (seen from the front), and the clutch plates 221 and 222 are disposed axially alternately. The front and rear surfaces of the clutch plates 221 and 222 are provided with linings (friction members).

The driving clutch plates 221 are axially movably fitted in splines formed on the inner circumferential surface of the large-diameter portion 185a of the tube plate 185. Thus, the driving clutch plates 221 are allowed to move in the front-rear direction, as well as are prohibited from rotating relative to the tube plate 185 and rotate integrally with the tube plate 185.

The driven clutch plates 222 are axially movably fitted to splines formed on a hub gear 115 of a torque damper apparatus 100 (to be discussed later). Thus, the driven clutch plates 222 are allowed to move in the front-rear direction, as well as are prohibited from rotating relative to the hub gear 115 and rotate integrally with the hub gear 115.

The front and rear surfaces of the driven clutch plates 222 are provided with linings (friction members). When the clutch piston 21 reaches the actuation position, the alternately disposed driving clutch plates 221 and driven clutch plates 222 are brought into contact with each other by pressure and engaged by the friction force of the linings. Subsequently, when the actuation pressure on the clutch piston 21 is released and the clutch piston 21 reaches the non-actuation position, the pressure contact between the driving clutch plates 221 and driven clutch plates 222 is released and both clutch plates are disengaged.

The torque inputted to the lock-up clutch 20 is transmitted to the turbine hub 19 through the torque damper apparatus 100. The configuration of the torque damper apparatus 100 will be described later.

The space SP1 between the turbine runner 12 and cover 18 is partitioned into a front actuation chamber SP11 and a rear actuation chamber SP12 by the clutch piston 21. The front actuation chamber SP11 is formed between the first plate 181 of the cover 18 and the first plate 211 of the clutch piston 21. Oil discharged from a pump (not shown) can be supplied to the front actuation chamber. The oil discharged from the pump can also be supplied to the rear actuation chamber SP12 through a path 26 between the shell 11a of the pump impeller 11 and the stator hub 14 or a path 27 between the inner ring 16 and turbine hub 19. The flow of the oil to the front actuation chamber SP11 and rear actuation chamber SP12 is controlled by a valve device (not shown).

When the oil from the pump is supplied to the rear actuation chamber SP12 through the path 26 or 27, the pressure of the rear actuation chamber SP12 becomes higher than that of the front actuation chamber SP11 and the clutch piston 21 is pushed forward. Thus, the clutch piston 21 is moved to the non-actuation position, and the contact pressure acting on the clutch plates 221 and 222 is removed, allowing the clutch plates 221 and 222 to rotate relative to each other (lock-up clutch non-actuated state). In this state, the torque of the output shaft of the engine is transmitted to the pump impeller 11 through the cover 18 and further transmitted to the turbine runner 12 through the oil flowing along the circulation path A passing the pump impeller 11, turbine runner 12, and stator 13. The torque of the turbine runner 12 is transmitted the input shaft of the transmission through the turbine hub 19.

On the other hand, when the oil from the pump is supplied to the front actuation chamber SP11, the pressure of the front actuation chamber SP11 becomes higher than that of the rear actuation chamber SP12 and the clutch piston 21 is pushed rearward. Thus, the clutch piston 21 is moved to the actuation position, the clutch plates 221 and 222 are brought into contact with each other by pressure and engaged so as to be integrally rotatable (lock-up clutch actuated state). In this state, the torque of the output shaft of the engine is transmitted to the input shaft of the transmission through the cover 18, clutch piston 21, torque damper apparatus 100, and turbine hub 19. That is, the turbine hub 19 is mechanically coupled to the cover 18 not through fluid. Thus, transmission loss due to fluid can be prevented.

When the cover 18 and turbine hub 19 are directly coupled during actuation of the lock-up mechanism, torque vibrations caused by variations in the rotation of the engine are directly transmitted to the transmission. To avoid this, the torque damper apparatus 100 having a vibration damping function is disposed between the lock-up clutch 20 and turbine hub 19. The torque damper apparatus 100 is disposed on the torque transmission path from the lock-up clutch 20 to the turbine hub 19 (output shaft) so as to be rotatable about the axis CL.

The torque damper apparatus 100 is disposed in the limited space (rear actuation chamber SP12) behind the clutch piston 21 and in front of the shell 12a of the turbine runner 12. To prevent upsizing of the torque converter 10, it is preferred to make compact the configuration of the torque damper apparatus 100 having a desired vibration damping function. For this reason, the torque damper apparatus 100 according to the present embodiment is configured as follows.

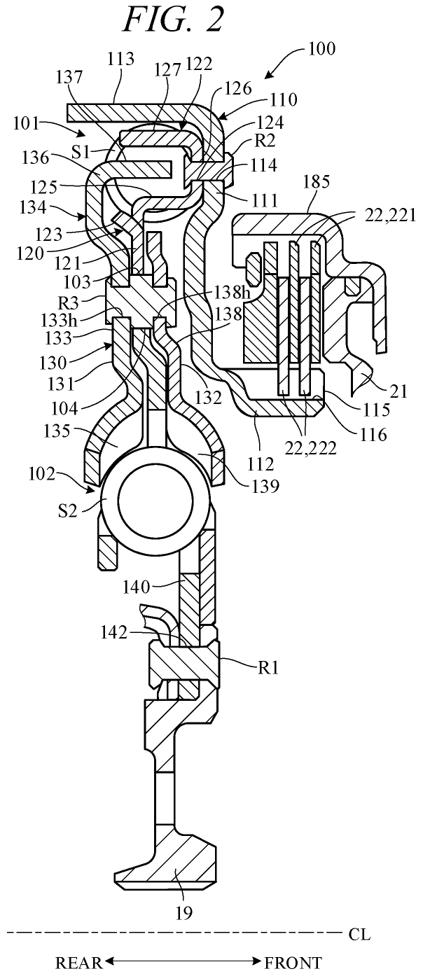

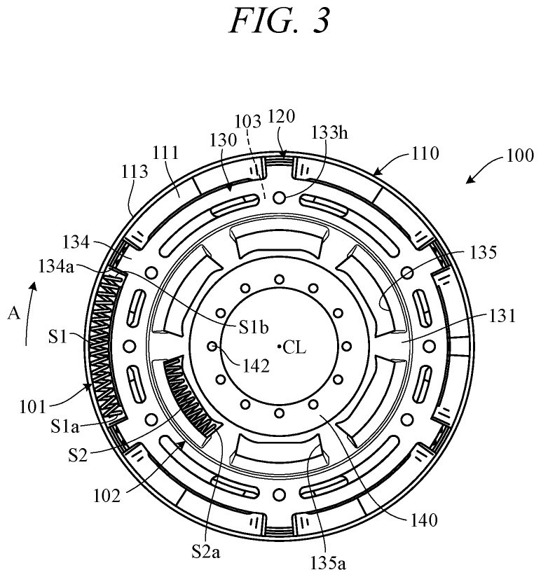

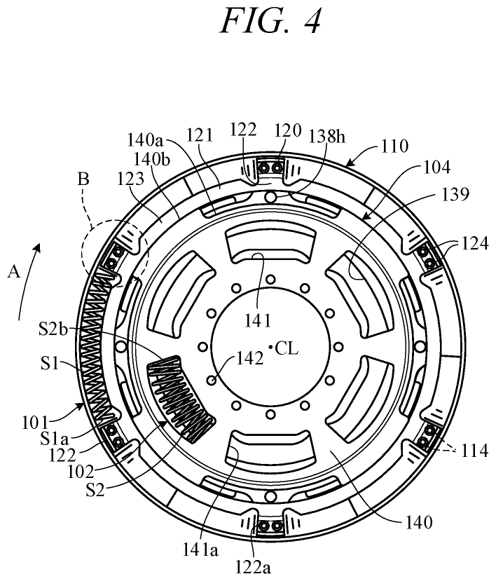

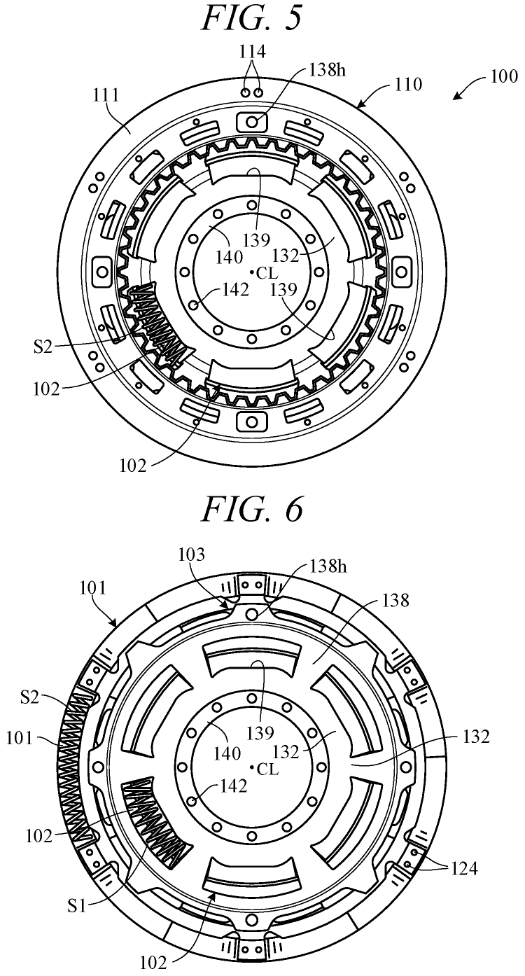

FIG. 2 is an enlarged sectional view showing the configuration of main components of the torque damper apparatus 100 in FIG. 1. FIGS. 3 and 4 are rear views of the torque damper apparatus 100 in FIG. 2. FIGS. 5 and 6 are front views of the torque damper apparatus 100 in FIG. 2. FIG. 4 omits illustration of a part (first plate member 131) of the torque damper apparatus 100 and FIG. 6 also omits illustration of a part (drive plate 110) thereof.

As shown in FIGS. 2 to 6, the torque damper apparatus 100 includes the drive plate 110, a holder plate 120, a torque transmission plate 130, a center plate 140, multiple primary damper springs S1, and multiple secondary damper springs S2. The torque damper apparatus 100 has, on the radially inner end thereof, an approximately circular opening to which the input shaft of the transmission (not shown) is fitted and that is centered on the axis CL.

The torque damper apparatus 100 also includes multiple (six) primary containers 101 containing the primary damper springs S1 and multiple (six) secondary containers 102 containing the secondary damper springs S2. For convenience, FIGS. 3 to 6 show one damper spring S1 contained in one container 101 and one container 102 contained in one damper spring S2. FIGS. 3 to 6 show the initial state of the torque damper apparatus 100, that is, the state of the torque damper apparatus 100 on which a torque has yet to act (the state before the damper springs S1 and S2 contract).

As shown in FIGS. 2 to 4, the primary containers 101 are circumferentially disposed at predetermined intervals on the radially outer end of the torque damper apparatus 100. The secondary containers 102 are circumferentially disposed at predetermined intervals on the radial inside of the primary containers 101.

The primary containers 101 and secondary containers 102 are disposed in approximately the same position in the front-rear direction. The term “approximately the same position” means that the positions of the centers in the front-rear direction need not necessarily match each other in the axial direction and the primary containers 101 and secondary containers 102 are located within a predetermined axial range. Such a configuration of the primary containers 101 and secondary containers 102 allows for axially downsizing the torque damper apparatus 100.

The primary damper springs S1 and secondary damper springs S2 are formed as coil springs that are centered on the axis CL and circumferentially extend approximately in the shape of arcs.

As shown in FIG. 2, the drive plate 110 includes a first plate 111 that extends radially, a second plate 112 that extends forward from the radially inner end of the first plate 111, and a third plate 113 that extends rearward from the radially outer end of the first plate 111.

The clutch plates 22 are disposed in front of the first plate 111, and the primary damper springs S1 are disposed behind the first plate 111. The first plate 111 is provided with portions of the primary containers 101 at the radially outer end of the rear surface, at which portions of the outer circumferential surfaces of the primary damper springs S1 are supported.

Through holes 114 that axially passes through the first plate 111 are provided at the radially outer end of the first plate 111. As shown in FIG. 4, the through holes 114 consist of pairs of through holes that are circumferentially disposed in multiple positions (six positions), that is, by every 60°. As shown in FIG. 2, rivets R2 are inserted into the through holes 114. The rivets R2 are also inserted into through holes 124 of the holder plate 120 disposed so as to correspond to the through holes 114, and the holder plate 120 is fastened to the drive plate 110 through the rivets R2.

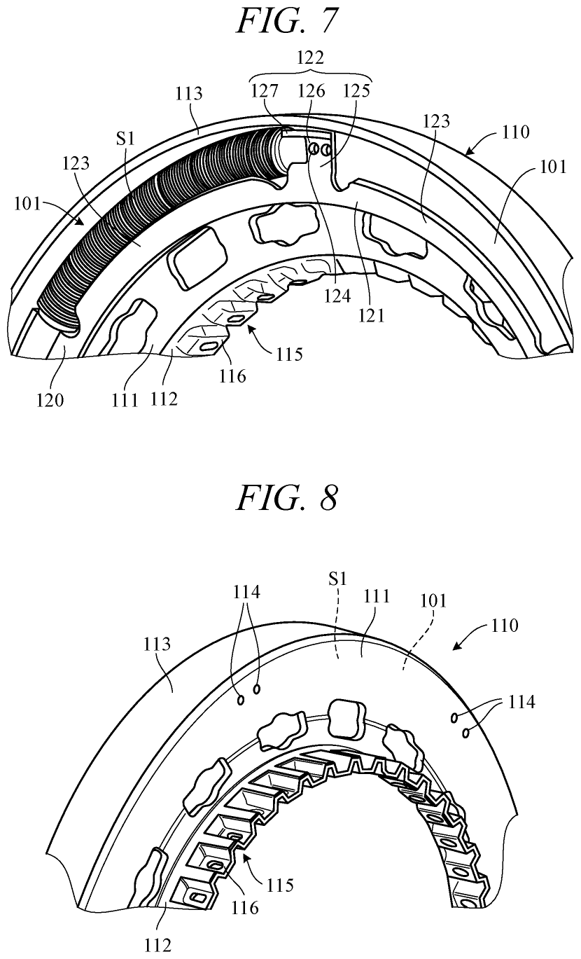

The second plate 112 is formed in an approximately cylindrical shape centered on the axis CL, and the hub gear 115 is formed on the outer circumferential surface thereof. When the clutch plates 221 and 222 are brought into contact with each other by pressure, the torque of the engine is transmitted to the hub gear 115. FIG. 7 is a perspective view of a portion B of FIG. 4 seen obliquely from the rear, and FIG. 8 is a perspective view of main components of the drive plate 110 seen obliquely from the front. As shown in FIGS. 7 and 8, the hub gear 115 is provided with splines 116 to which the radially inner ends of the driven clutch plates 222 are fitted so as to be movable in the axial direction.

As shown in FIG. 2, the third plate 113 is formed in an approximately cylindrical shape centered on the axis CL. The primary damper springs S1 are disposed on the radial inside of the third plate 113. Specifically, the third plate 113 configures the primary containers 101 with the first plate 111 and holds the radially outer ends centered on the axis CL, of the outer circumferential surfaces of the primary damper springs S1.

As seen above, the drive plate 110 has thereon the hub gear 115 that receives the torque from the lock-up clutch 20, as well as configures the primary containers 101, and holds front portions and radial outer portions of the outer circumferential surfaces of the primary damper springs S1. This configuration eliminates the need to separately dispose a thick member for holding the primary damper springs S1 on which centrifugal forces act radially outward and thus allows for efficiently holding the primary damper springs S1.

The torque from the drive plate 110 is transmitted to the holder plate 120 and further transmitted to the torque transmission plate 130 through the primary damper springs S1. The holder plate 120 is disposed behind the first plate 111 of the drive plate 110 and on the radial inside of the third plate 113. The holder plate 120 is configured with circular openings centered on the axis CL. The diameter of the holder plate 120 is smaller than the diameter of the drive plate 110. The thickness of the holder plate 120 is smaller than the thickness of the drive plate 110. Therefore, it is possible to reduce the weight of the torque damper apparatus 100 and suppress cost increase.

The holder plate 120 includes a plate 121 that extends radially, protrusions 122 that are circumferentially disposed so as to protrude radially outward from the radially outer end of the plate 121, and multiple spring holders 123 that extend in a rearward and radially outward direction from the radially outer end of the plate 121.

The plate 121 extends approximately in parallel with the first plate 111 on the radial inside of the primary damper springs S1 and behind the first plate 111. The radially inner end (inner circumferential surface) of the plate 121 is rotatably fitted to the torque transmission plate 130 (outer fitting portions 103 (to be discussed later)).

The protrusions 122 are circumferentially formed in six positions corresponding to the positions of the pairs of through holes 114 formed in the first plate 111 of the drive plate 110. That is, the protrusions 122 are protruded radially outward so as to cover the pairs of through holes 114.

The protrusions 122 are provided with pairs of through holes 124 corresponding to the positions of the pairs of through holes 114. The rivets R2 are inserted into the through holes 114 and 124 and thus the holder plate 120 is fastened to the drive plate 110. The drive plate 110 and holder plate 120 are fastened to each other in the circumferentially disposed six positions, and the primary damper springs S1 are disposed in the spaces between the fastening portions. Thus, as shown in FIG. 7, the ends in the expansion/contraction direction of the primary damper springs S1 are supported by the protrusions 122 so that the torque can be transmitted to the primary damper springs S1.

As shown in FIGS. 2 and 7, the protrusions 122 have approximately C-shaped cross-sections. More specifically, each protrusion 122 includes a first plate 125 that extends forward from the radially outer end of the plate 121, a second plate 126 that extends radially outward from the front end of the first plate 125, and a third plate 127 that extends rearward from the radially outer end of the second plate 126.

The first plate 125 extends until reaching the first plate 111 of the drive plate 110. The second plate 126 extends approximately in parallel with the first plate 111 of the drive plate 110 and is in contact with the rear surface of the first plate 111. The second plate 126 is provided with the pair of through holes 124. The third plate 127 extends approximately in parallel with the third plate 113 on the radial inside of the third plate 113 of the drive plate 110. The first plate 125, second plate 126, and third plate 127 are in contact with an end surface in the circumferential direction (expansion/contraction direction) of the primary damper spring S1.

More specifically, the first plate 125, third plate 127, and second plate 126 of the protrusion 122 are in contact with the end surface of the primary damper spring S1 on the radial inside, the radial outside, and the front side, respectively, of a center line passing through the center (coil center) of the primary damper spring S1 extending along the expansion/contraction direction of the primary damper spring S1, respectively. The first plate 125 and third plate 127 are formed approximately in parallel with each other, and the radial distance between the first plate 125 and third plate 127 is longer than the radius of the primary damper spring S1 and shorter than the diameter thereof. The lengths in the front-rear direction of the first plate 125 and third plate 127 are longer than the radius of the primary damper spring S1 and shorter than the diameter thereof.

This configuration allows for uniformly pressing the entire end surface of the primary damper spring S1 and thus smoothly expanding and contracting the primary damper spring S1. The protrusions 122 need not have approximately C-shaped cross-sections and are preferably formed so as to uniformly press the primary damper springs S1.

As shown in FIG. 7, the spring holders 123 extend in a radial outward-rearward direction from the radially outer end of the plate 121 between the protrusions 122 and 122 disposed at equal intervals in the circumferential direction. The outer circumferential surfaces of the spring holders 123 are in contact with radially inner-rear portions of the outer circumferential surfaces of the primary damper springs S1. The outer circumferential surfaces of the spring holders 123 configure portions of the primary containers 101 and hold the radially inner-rear portions of the outer circumferential surfaces of the primary damper springs S1.

As seen above, the primary containers 101 are configured by the radially outer end of the first plate 111 of the drive plate 110, the third plate 113 of the drive plate 110, and the spring holders 123 of the holder plate 120, and are provided between the circumferentially disposed protrusions 122 and 122.

The torque transmitted to the primary damper springs S1 is outputted to the torque transmission plate 130. As shown in FIG. 2, the torque transmission plate 130 is disposed behind the first plate 111 of the drive plate 110 and on the radial inside of the third plate 113 of the drive plate 110.

The torque transmission plate 130 includes the first plate member 131, a second plate member 132 disposed in front of the first plate member 131, and rivets R3 that are circumferentially disposed and fasten the first plate member 131 and second plate member 132 with the plate members spaced from each other in the axial direction (front-rear direction).

The first plate member 131 includes a plate 133 that extends approximately radially, multiple protrusions 134 that are circumferentially disposed and protrude radially outward from the radially outer end of the plate 133, and multiple containing openings 135 that are circumferentially provided on the radially inner end of the plate 133.

The plate 133 extends approximately in parallel with the first plate 111 on the radial inside of the primary damper springs S1 and behind the first plate 111. An approximately circular opening is provided on the radially inner end of the plate 133. Further at the plate 133, through holes 133h are provided in circumferentially multiple positions so as to axially pass through the plate 133. The rivets R3 are inserted into the through holes 133h.

The protrusions 134 are formed in circumferentially disposed six positions corresponding to the positions of the protrusions 122 of the holder plate 120. The primary containers 101 are circumferentially formed between the protrusions 134 and 134 and contain the primary damper springs S1. As shown in FIG. 2, the protrusions 134 are formed in approximately L-shaped cross-sections. Specifically, each protrusion 134 includes a first plate 136 that extends radially outward from the radially outer end of the plate 133 and a second plate 137 that extends forward from the first plate 136.

The first plate 136 extends to radial positions between the first plates 125 and third plates 127 of the protrusions 122 of the holder plate 120. The second plate 137 extends forward between the first plates 125 and third plates 127 so as to cross center lines passing through the centers (coil centers) of the primary damper springs S1 extending along the expansion/contraction direction of the primary damper springs S1. The torque outputted from the holder plate 120 is inputted to end surfaces (first end surfaces) in the circumferential direction of the primary damper springs S1 through the protrusions 122 and further transmitted to the protrusions 134 of the first plate member 131 through the other end surfaces (second end surfaces) in the circumferential direction of the primary damper springs S1. At this time, the torque variations are reduced by the primary damper springs S1.

The circumferentially disposed containing openings 135 are formed so as to hold rear portions of the outer circumferential surfaces of the secondary damper springs S2. That is, the containing openings 135 configure portions of the secondary containers 102 and the secondary damper springs S2 are contained and held by the containing openings 135.

The second plate member 132 is disposed behind the drive plate 110 and in front of the first plate member 131. The second plate member 132 includes a plate 138 that extends approximately radially and multiple containing openings 139 that are circumferentially provided on the radially inner end of the plate 138.

The plate 138 is disposed on the radial inside of the primary damper springs S1 and between the drive plate 110 and the plate 133 of the first plate member 131. At the plate 138, axially oriented multiple through holes 138h are circumferentially provided so as to correspond to the positions of the through holes 133h. The rivets R3 are inserted into the through holes 138h.

The circumferentially disposed containing openings 139 are formed so as to hold front portions of the outer circumferential surfaces of the secondary damper springs S2. That is, the containing openings 139 configure portions of the secondary containers 102, and the secondary damper springs S2 are contained and held by the containing openings 139.

Between the plate 133 of the first plate member 131 and the plate 138 of the second plate member 132 fastened to each other by the rivets R3, the outer circumferential surfaces of the rivets R3 configure portions of the outer fitting portions 103 to which the radially inner end of the plate 121 of the holder plate 120 is rotatably fitted and portions of inner fitting portions 104 to which the radially outer end of the center plate 140 is rotatably fitted. That is, radially outer portions of the outer circumferential surfaces of the rivets R3 centered on the axis CL configure portions of the outer fitting portions 103, and radially inner portions of the outer circumferential surfaces configure portions of the inner fitting portions 104.

The radially inner end of the plate 121 of the holder plate 120 is disposed over the outer fitting portions 103 with predetermined clearances therebetween that allow for axially positioning the radially inner end with respect to the outer circumferential surfaces of the rivets R3. The radially outer end of the center plate 140 is disposed over the inner fitting portions 104 with predetermined clearances therebetween that allow for axially positioning the radially outer end with respect to the outer circumferential surfaces of the rivets R3. As shown in FIG. 4, the inner circumferential surface of the holder plate 120 can contact the outer circumferential surfaces of the rivets R3 and the outer circumferential surface of the center plate 140. Thus, the holder plate 120 is radially positioned.

The torque from the torque transmission plate 130 is transmitted to the center plate 140 through the secondary damper springs S2 and further outputted from the center plate 140 to the turbine hub 19. The center plate 140 includes approximately arc-shaped small-diameter portions 140a and large-diameter portions 140b that are both centered on the axis CL and provided alternately in the circumferential direction. Radially inner portions of the outer circumferential surfaces of the rivets R3 are in contact with the small-diameter portions 140a, and the inner circumferential surface of the holder plate 120 is in contact with the large-diameter portions 140b.

As shown in FIG. 2, the center plate 140 is disposed on the radial inside of the rivets R3 and between the first plate member 131 and second plate member 132. The inner circumferential surface of the center plate 140 is fitted to a step of the turbine hub 19. The radially inner end of the center plate 140 is provided with multiple through holes 142 that are circumferentially disposed. The rivets R1 penetrating the turbine hub 19 are inserted into the through holes 142 and thus radial movement of the center plate 140 is regulated.

As shown in FIG. 4, the center plate 140 is also provided with containing openings 141 that are circumferentially disposed and contain the secondary damper springs S2. When the torque from the torque transmission plate 130 is inputted to first circumferential end surfaces of the secondary damper springs S2, the torque is further inputted to the center plate 140 through second circumferential end surfaces of the secondary damper springs S2 and end surfaces of the containing openings 141. At this time, the torque variations are reduced by the secondary damper springs S2.

To assemble the torque damper apparatus 100 thus configured, first, the drive plate 110 and holder plate 120 are fastened to each other using the rivets R2 while adjusting the positions of the through holes 114 of the drive plate 110 and the through holes 124 of the holder plate 120. That is, a unit member in which the drive plate 110 and holder plate 120 are combined, is formed.

Then, this unit member is disposed between the first plate member 131 and second plate member 132 of the torque transmission plate 130, and the center plate 140 containing the secondary damper springs S2 is also disposed therebetween. The first plate member 131 and second plate member 132 are fastened to each other using the rivets R3 while adjusting the positions of the through holes 133h of the first plate member 131 and the through holes 138h of the second plate member 132. Also, the primary damper springs S1 are put into the primary containers 101 of the drive plate 110. Thus, the torque damper apparatus 100 is assembled in which the holder plate 120 is rotatably fitted to the outer fitting portions 103 of the torque transmission plate 130 (rivets R3).

The operation of the torque damper apparatus 100 according to the present embodiment will be described. Assume that by actuating the lock-up clutch 20, the torque from the engine is inputted to the drive plate 110 through the lock-up clutch 20, resulting in rotation of the drive plate 110 in the direction of an arrow A in FIGS. 3 and 4.

At this time, pressing forces from circumferential end surfaces 122a of the protrusions 122 act on first circumferential end surfaces S1a of the primary damper springs S1. Thus, the primary damper springs S1 contract, and the drive plate 110 and holder plate 120 rotate relative to the torque transmission plate 130 accordingly. The torque from second circumferential end surfaces S1b of the primary damper springs S1 acts on first circumferential end surfaces 134a of the protrusions 134 of the first plate member 131 of the torque transmission plate 130 in the direction of the arrow A. Thus, the torque transmission plate 130 rotates in the direction of the arrow A while the torque variations are reduced by the primary damper springs S1.

Due to the rotation of the torque transmission plate 130, pressing forces from first circumferential end surfaces 135a of the containing openings 135 act on first circumferential end surfaces S2a of the secondary damper springs S2. Thus, the secondary damper springs S2 contract, and the torque transmission plate 130 rotates relative to the center plate 140 accordingly. The torque from second circumferential end surfaces S2b of the secondary damper springs S2 acts on first circumferential end surfaces 141a of the containing openings 141 of the center plate 140 in the direction of the arrow A. Thus, the center plate 140 rotates in the direction of the arrow A while the torque variations are reduced by the secondary damper springs S2.

In this way, the torque inputted through the lock-up clutch 20 is transmitted to the turbine hub 19 through the drive plate 110, holder plate 120, torque transmission plate 130, and center plate 140.

The present embodiment can achieve advantages and effects such as the following:

(1) The torque damper apparatus 100 is disposed on a torque transmission path to the turbine hub 19 from the lock-up clutch 20 to which torque output from the engine is input and configured so as to be rotatable about the axis CL (FIG. 1). The torque damper apparatus includes: the drive plate 110 (an input plate) to which torque is input from the lock-up clutch 20; the holder plate 120 (an intermediate plate) fastened to the drive plate 110; the torque transmission plate 130 (an output plate) to which torque is transmitted from the holder plate 120; and the primary damper springs S1 (a spring member) interposed between the holder plate 120 and the torque transmission plate 130 so that the torque transmitted from the holder plate 120 to the torque transmission plate 130 is reduced (FIGS. 2 to 4). The torque transmission plate 130 includes the first plate member 131 and the second plate member 132 (a pair of plates) arranged so as to separate from each other in the axial direction and the rivets R3 (a fastening part) that integrally fastens the pair of plate members 131 and 132 (FIG. 2). The primary damper springs S1 are configured as coiled springs arranged in expandable and contractable manner along the circumferential direction about the axis CL (FIGS. 3 and 4). The holder plate 120 includes the spring holders 123 that hold the inner end of the primary damper springs S1 in the radial direction about the axial line, and the plate 121 extended from the spring holders 123 toward the inside in the radial direction between the pair of plate members 131 and 132 and supported rotatably relative to the rivets R3 (FIG. 2).

Therefore, it is possible to reduce the size of the torque damper apparatus 100 in the axial direction by means of simple configurations. As a result, it is easy to apply the torque damper apparatus 100 to the multi-plate type lock-up clutch 20, while suppressing increase of the number of parts.

(2) The plate 121 of the holder plate 120 is located on the inside of the primary damper spring S1 in the radial direction and between an end (the front end) and another end (the rear end) of the primary damper spring S1 in the axial direction (FIG. 2). Therefore, it is possible to rotatably dispose the holder plate 120 relative to the torque transmission plate 130 within the width (diameter) of the primary damper spring S1 and to downsize the torque damper apparatus 100 in the axial direction.

(3) The drive plate 110 includes the third plate 113 that holds the outer end of the primary damper spring S1 in the radial direction (FIG. 2). Therefore, since centrifugal force of the primary damper spring S1 acts on the drive plate 110 with high rigidity, it is not necessary to provide an additional member with high rigidity on the radially outside of the primary damper spring S1 and to suppress increase of the number of parts.

(4) The primary damper spring S1 includes multi primary damper springs (a first spring member and a second spring member) in the circumferential direction disposed between the first plate member 131 and the drive plate 110 (first plate 111) and disposed facing the radially outer end (third plate 113) of the drive plate 110 with a predetermined space between each other (FIGS. 3 and 4). Therefore, torque variation of the engine can be favorably reduced.

(5) The torque transmission plate 130 includes protrusions 134 (a torque input portion) formed in a substantially L-shape in cross-section, disposed between end surfaces S1a and S1b in the circumferential direction of the pair of primary damper springs S1 facing each other so that torque is input through the primary damper spring S1 (FIGS. 2 and 3). Therefore, it is possible to satisfactorily transmit torque from the primary damper spring S1 to the torque transmission plate 130 without increasing the size of the torque damper apparatus 100 in the axial direction.

(6) The holder plate 120 further includes the protrusions 122 formed in a substantially C-shape in cross-section and disposed between the end surfaces S1a and S1b of the primary damper springs S1 facing each other in the circumferential direction so as to transmit torque to the primary damper spring S1 (FIGS. 2 and 4). Therefore, it is possible to satisfactorily transmit torque from the holder plate 120 to the primary damper spring S1 without increasing the size of the torque damper apparatus 100 in the axial direction.

(7) The torque damper apparatus 100 includes the center plate 140 (a second output plate) to which torque output from the torque transmission plate 130 (a first output plate) is transmitted, and the secondary damper springs S2 (a secondary spring member) interposed between the torque transmission plate 130 and the center plate 140 so that the torque transmitted from the torque transmission plate 130 to the center plate 140 is reduced (FIGS. 2 to 4). Therefore, since the primary damper springs S1 and the secondary damper springs S2 are disposed in series in the torque transmission path from the lock-up clutch 20 to the turbine hub 19, vibration absorbing effect is improved. As a result, it is possible to effectively reduce torque variation of the engine.

(8) The secondary damper springs S2 are located on the radially inside of the rivets R3 (FIG. 2). Since centrifugal force acting on the secondary damper springs S2 is small, it is possible to obtain favorable damping force by the secondary damper springs S2.

(9) The primary damper springs S1 and the secondary damper springs S2 are located at the substantially same position in the axial direction (FIG. 2). Therefore, it is possible to reduce the size in the axial direction of the torque damper apparatus 100 having the pair of damper springs S1 and S2.

(10) The drive plate 110 includes the hub gear 115 where driven clutch plates 222 of the lock-up clutch 20 are engaged in a movable manner in the axial direction (FIG. 8). Therefore, in the apparatus including the lock-up clutch increased in axial length, as multi-plate type clutch increasing torque capacity, it is possible to suppress increase of the number of parts and reduce the size of the apparatus as a whole.

(11) The drive plate 110 includes the first plate 111 extended in the radial direction and the second plate 112 extended from the axially inner end of the first plate 111 toward the axial direction and formed in a substantially cylindrical shape about the axis CL (FIG. 2). The hub gear 115 (an engagement portion) is formed on the outer peripheral surface of the second plate 112 (a hub portion). Therefore, it is possible to effectively dispose multi-clutch plates 22 in a space in front of the drive plate 110 and on the outside in the radial direction of the second plate 112.

Although in the aforesaid embodiment, the torque damper apparatus 100 is configured to include the drive plate 110, the holder plate 120, the torque transmission plate 130, the center plate 140, and multiple primary and secondary damper springs S1 and S2, a torque damper apparatus may be configured to omit the center plate 140 and the secondary damper springs S2. In the aforesaid embodiment, the torque damper apparatus 100 is disposed in the torque transmission path from the lock-up clutch 20 (a clutch device) to the turbine hub 19 (an output shaft). However, the configurations of the clutch device and the output shaft are limited to the above configurations.

The above embodiment can be combined as desired with one or more of the above modifications. The modifications can also be combined with one another.

According to the present invention, it is possible to downsize the torque damper apparatus in the axial direction and suppress increase of the number of parts.

Above, while the present invention has been described with reference to the preferred embodiments thereof, it will be understood, by those skilled in the art, that various changes and modifications may be made thereto without departing from the scope of the appended claims.

What is claimed is:

1. A torque damper apparatus, disposed on a torque transmission path to an output shaft from a clutch device to which a torque output from an engine is input, so as to be rotatable about an axial line,
the torque damper apparatus comprising:
an input plate to which a torque is input from the clutch device;
an intermediate plate fastened to the input plate;
an output plate to which a torque is transmitted from the intermediate plate; and
a spring member interposed between the intermediate plate and the output plate so that the torque transmitted from the intermediate plate to the output plate is reduced, wherein
the output plate includes a pair of plates arranged so as to separate from each other in an axial direction and a fastening part configured to fasten the pair of plates,
the spring member is a coiled spring arranged in an expanded and contracted manner along a circumferential direction about the axial line, and
the intermediate plate includes a holding portion configured to hold an inner end of the spring member in a radial direction about the axial line, and a plate portion extended from the holding portion toward an inside in the radial direction between the pair of plates and supported rotatably relative to the fastening part.

2. The torque damper apparatus according to claim 1, wherein
the plate portion is located on an inside in the radial direction of the spring member and between an end and another end in the axial direction of the spring member.

3. The torque damper apparatus according to claim 1, wherein
the input plate includes a holding portion configured to hold an outer end in the radial direction of the spring member.

4. The torque damper apparatus according to claim 1, wherein
the input plate includes a plate portion extended in the radial direction and an outer plate portion extended in the axial direction from an outer end in the radial direction of the plate portion of the input plate,
the pair of plates includes a first plate and a second plate interposed between the first plate and the plate portion of the input plate, and
the spring member includes a first spring member and a second spring member disposed between the first plate and the portion of the input plate and facing the outer plate portion of the input plate with a predetermined space between the first spring member and the second spring member.

5. The torque damper apparatus according to claim 4, wherein
the output plate includes a torque input portion to which the torque is input through the first spring member or the second spring member, and
the torque input portion is formed in a substantially L-shape in a cross-section and disposed between an end surface in the circumferential direction of the first spring member and an end surface in the circumferential direction of the second spring member facing each other.

6. The torque damper apparatus according to claim 4, wherein
the intermediate plate further includes a torque transmission portion formed in a substantially C-shape in a cross-section and disposed between an end surface of the first spring member and an end surface of the second spring member facing each other in the circumferential direction so as to transmit the torque to the first spring member or the second spring member.

7. The torque damper apparatus according to claim 1, wherein
the output plate is a first output plate,
the spring member is a primary spring member, and
the torque damper apparatus further comprises:
a second output plate to which a torque output from the first output plate is transmitted; and
a secondary spring member interposed between the first output plate and the second output plate so that the torque transmitted from the first output plate to the second output plate is reduced.

8. The torque damper apparatus according to claim 7, wherein
the secondary spring member is located on an inside in the radial direction of the fastening part.

9. The torque damper apparatus according to claim 7, wherein
the primary spring member and the secondary spring member are located at a substantially same position in the axial direction.

10. The torque damper apparatus according to claim 1, wherein
the input plate includes an engagement portion configured to engage a clutch plate of the clutch device in a movable manner in the axial direction.

11. The torque damper apparatus according to claim 10, wherein
the input plate includes a plate portion extended in the radial direction and a hub portion extended in the axial direction from an inner end in the radial direction of the plate portion of the input plate, and
the engagement portion is formed on a peripheral surface of the hub portion.

12. The torque damper apparatus according to claim 1, wherein
the axis is consistent with a central axis of the output shaft.
